(19) United States
(12) Patent Application Publication
(10) Pub. No.: US 2004/0087210 A1
(43) Pub. Date: May 6, 2004

(54) Tethered electrical component for vehicles

(76) Inventor: David L. Mannes, Holland, MI (US)

Correspondence Address: PRICE HENEVELD COOPER DEWITT & LITTON, LLP, 695 KENMOOR, S.E., P O BOX 2567, GRAND RAPIDS, MI, 49501, US

(21) Appl. No.: 10/283,711

(22) Filed: Oct. 30, 2002

(51) Int. Cl. H01R 9/11

(52) U.S. Cl. 439/623

(57) ABSTRACT

An apparatus includes an electrical component with internal circuit, and a tether for keeping the electrical component in an easily-found position close to a location of future use. The tether has a first end attached to the electrical component with an adhesive first patch, a length wound around the electrical component, and a second end with an adhesive second patch, such as for adhering it to a vehicle body or headliner. The first and second patches include mating hook and loop material for releasable engagement to retain the tether in a wound storage position. In another form, the length is releasably held to permit sections of the tether to be pulled loose one at a time.

### BACKGROUND OF THE PRESENT INVENTION

The present invention relates to tethered components, such as a tethered electrical component for vehicles.

Circumstances often occur where it is desirable to secure a component to a mobile product prior to when the component is physically operably connected to the mobile product. For example, one such circumstance occurs when a “dummy” electrical component is used on automobiles, where the dummy component, when plugged in, fools the vehicle electrical system into believing and functioning as if the vehicle's passenger side air bag is operably connected and functioning. In such case, it is desirable to attach the dummy electrical component to the vehicle prior in a manner that keeps the component from being lost and keeps the dummy component in an easy-to-find location on the vehicle. It is important that cost be minimized, that a size of the stored dummy component be minimized, that minimal or no added cost be added to the dummy component for shipping, and that shipping be constructed to prevent tangling. It is also important that assembly of the component to the vehicle not be delayed or slowed by overcoming the anti-tangling feature, and/or that assembly not be delayed or slowed when attaching the apparatus to the vehicle for temporary securement.

Accordingly, an apparatus is desired solving the aforementioned problems and having the aforementioned advantages.

### SUMMARY OF THE PRESENT INVENTION

In one aspect of the present invention, an apparatus includes an electrical component adapted for operative interconnection to a vehicle electrical system, and an improvement comprising a tether attached to the electrical component. The tether has a first end attached to the electrical component and also has a length wound around the electrical component. The tether further has a second end releasably coupled to one of the first end, the length and the electrical component to hold the length in a wound condition on the electrical component.

In another aspect of the present invention, an apparatus for use in vehicles includes an electrical component adapted for operative interconnection to a vehicle electrical system, and a tether. The tether has a first end attached to the electrical component and has an elongated tethering member extending from the first end. The tether further has a second end adapted for repeated releasable attachment to the first end. The elongated tethering member has a length defining a maximum distance, but is arranged in a storage position to shorten an effective total distance between the first and second ends until the tethering member is extended to an extended position permitting the electrical component to be manipulated and used. In one form, the tether is wound around the electrical component. In another form, the tether is folded back and forth and held in its collapsed state by a releasable holder.

In another aspect of the present invention, a method comprises steps of providing an electrical component and a tether attached to the electrical component. The tether has an elongated tethering member positioned in a shortened storage position and includes a material releasably holding the tethering member in the storage position. The method further includes releasing and extending the tethering member to allow manipulation and use of the electrical component. In one form, the step of releasing and extending includes sequentially releasing single sections of the length of the tether member. In another form, the step of providing the tether in the shortened storage position includes winding the tether around the electrical component. In still another form, the step of providing the tether in the shortened storage position includes folding the tether back and forth, and holding the tether in the storage position in a manner permitting sections of the tether to be pulled free one at a time.

These and other aspects, objects, and features of the present invention will be understood and appreciated by those skilled in the art upon studying the following specification, claims, and appended drawings.

### BRIEF DESCRIPTION OF DRAWINGS

FIG. 1 is a fragmentary perspective view of a vehicle passenger compartment, looking at a right front area near the vehicle's “A” pillar where the present tethering apparatus is located;

FIG. 1A is a side view of a vehicle including its “C” pillar including the present tethering apparatus;

FIG. 2 is a plan view of the tethering apparatus of FIG. 1;

FIGS. 3 and 4 are plan views of the tethering apparatus of FIG. 2, FIG. 3 showing the tether partially wound onto the electrical component and FIG. 4 showing the tether fully wound onto the electrical component;

FIG. 5 is a plan view of the tethering apparatus of FIG. 2, but showing an alternative wound arrangement; and

FIG. 6 is a plan view of the tethering apparatus of FIG. 2, but showing an alternative arrangement where the tether is held in a back-and-forth folded position by a tape holder.

FIG. 7 is a plan view of the tethering apparatus of FIG. 2, but showing an alternative wound arrangement where a tape holder keeps the windings on the component housing.

### DETAILED DESCRIPTION OF PREFERRED EMBODIMENTS

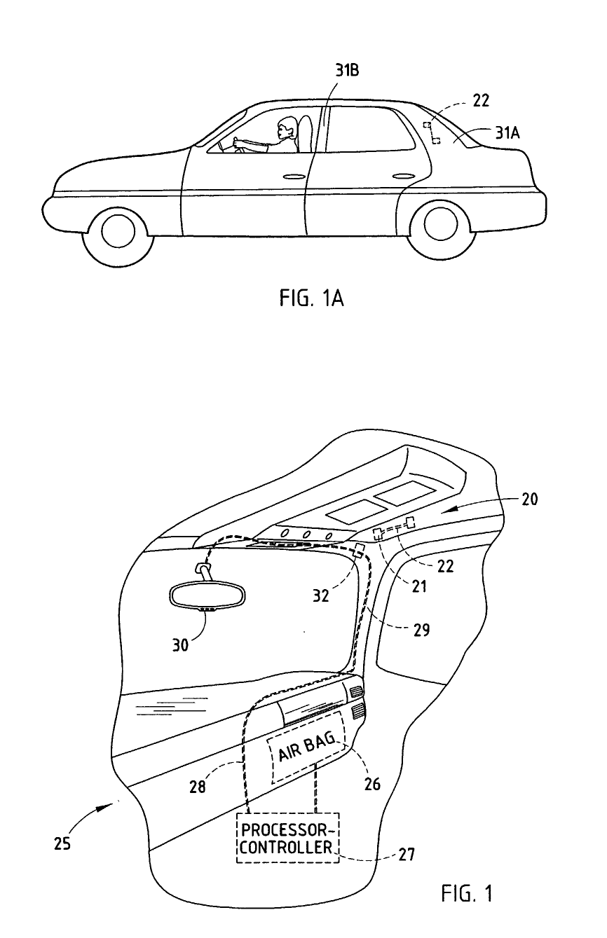

A tethered apparatus 20 (FIG. 1) includes an electrical component 21 and a tether assembly 22 (herein called a “tether”) adapted for keeping the electrical component 21 in an easily-found position close to a location of future use. In the illustrated apparatus 20, the electrical component 21 comprises a “dummy” secondary circuit including a resistor for replacing part of a passenger side air bag circuit in a vehicle, so that the vehicle computer system will “believe” and function as if the passenger air bag system is present and operative. The electrical component 21 of the present apparatus 20 is only added (and later connected) if the passenger side air bags are not needed. By using the apparatus 20, the electrical component 21 can be placed in a vehicle at an early stage of production (i.e. well prior to when it can be installed) without risk of the component 21 being lost or misplaced. Further, the apparatus 20 provides for quick and easy attachment/detachment of the tether 22 to the vehicle, and still further provides for compact storage of the apparatus 20 (including the tether 22) during shipping, installation and until use, and still further provides for easy extension of the tether 22 to permit manipulation and reorientation of the component 21 during the assembly process when connecting the electric component to the vehicle electrical circuit for use.

The present electrical component 21 is very advantageous since it allows automobile manufacturers to make automobiles with similar electrical systems, thus taking advantage of mass production and assembly techniques. At the same time, it allows the manufacturers to optionally and easily provide customers with vehicles not having passenger side air bags, such as when a customer chooses not to have one for reasons related to child safety. The dummy circuit can also be used for testing purposes. In particular, the illustrated apparatus 20 allows an assembly worker or repairman to attach the dummy circuit to a vehicle body at an appropriate logical time during assembly or repair of the vehicle, and to keep the dummy circuit at a location where it is easily found for later use. Though the present invention is described in terms of the present electrical component 21, it is noted that the present invention focuses on the tethering aspects of the present apparatus. More specifically, the present apparatus is believed to be highly useful for any situation, particularly in mass production or in mobile complex products, where a component needs to be attached to a mobile object and held in an easily-found position for later installation or use.

FIG. 1 shows a vehicle 25 having a passenger side air bag 26, a vehicle electrical system including a processor-controller 27 operably connected to the passenger side air bag 26, and a vehicle control circuit 28 extending up the vehicle's “A” pillar 29 and above the vehicle's headliner to a vehicle mirror having a switch 30 for turning the passenger side air bag 26 on or off. The illustrated apparatus 20 of FIG. 1 happens to be positioned at the vehicle “A” pillar 31 above the headliner where a connector 32 is located, but it is contemplated that the illustrated apparatus 20 could be positioned at other locations where the component 21 can be operably connected to the circuit 28. For example, see FIG. 1A, which shows a tether 22 located in a vehicle's “C” pillar 31A. The tether could also be located at the “B” pillar 31B, if desired.

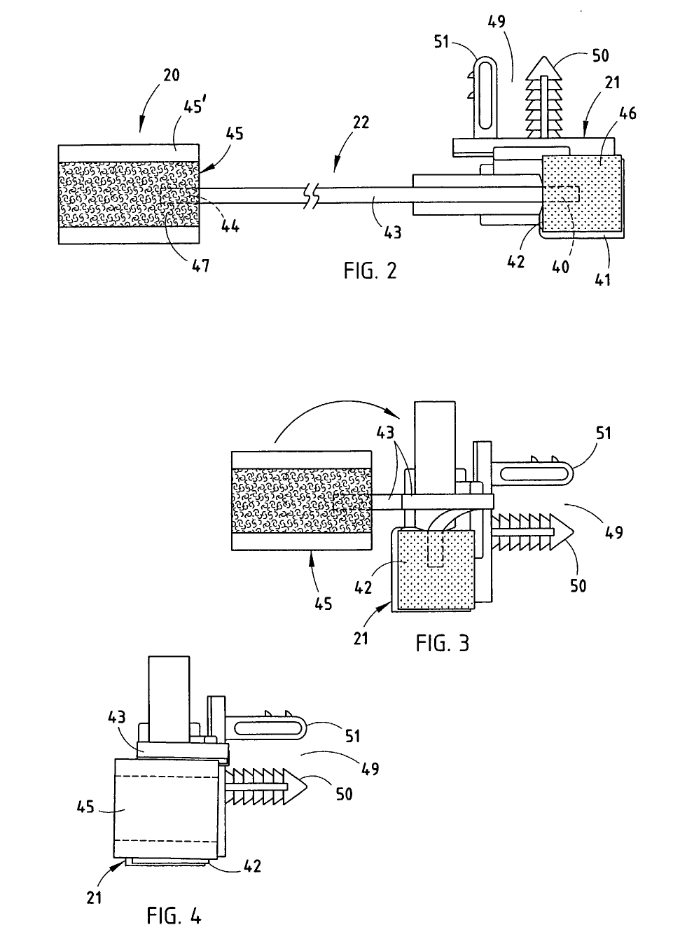

The tether 22 (FIG. 2) includes a first patch 42 and a first end 40 attached to a flat side surface 41 of the electrical component 21 with an adhesive side of the first patch 42. The tether 22 further includes a length of a fabric or ribbon 43 (i.e. the “tether member”) wound around the electrical component 21, and a second end 44 attached to the sticky adhesive side of a second patch 45. The tether member 43 can be wound in either direction around the component 21, but it is desirable to have the loop material on the second patch 45 be positioned at the hook material on the first patch 42 when the length is wrapped tightly around the component 21. The adhesive side of the second patch 45 can be quickly and easily adheringly attached to the vehicle body (or to the headliner itself) by removing the non-stick release paper 45′, such as to expose its adhesive. The illustrated second patch 45 is bonded to the vehicle body metal above the headliner (or to the headliner itself) near the “A” pillar 31, but it is contemplated that it can be attached anywhere desired in the vehicle. The first and second patches 42 and 45 include a side covered with mating hook and loop material 46 and 47, respectively, for multiple releasable engagement. When engaged as shown in FIG. 4, the tether 22 is retained in a wound storage position by being located in a recess 49 between protrusions 50 and 51 on the component 21. The assembly 20, when in the tightly wound compact storage position, has the advantage that it basically does not take up any more room than the electrical component 21 alone. Thus, the arrangement provides substantial advantages for shipping and material handling. Further, the tether 22 is very lightweight.

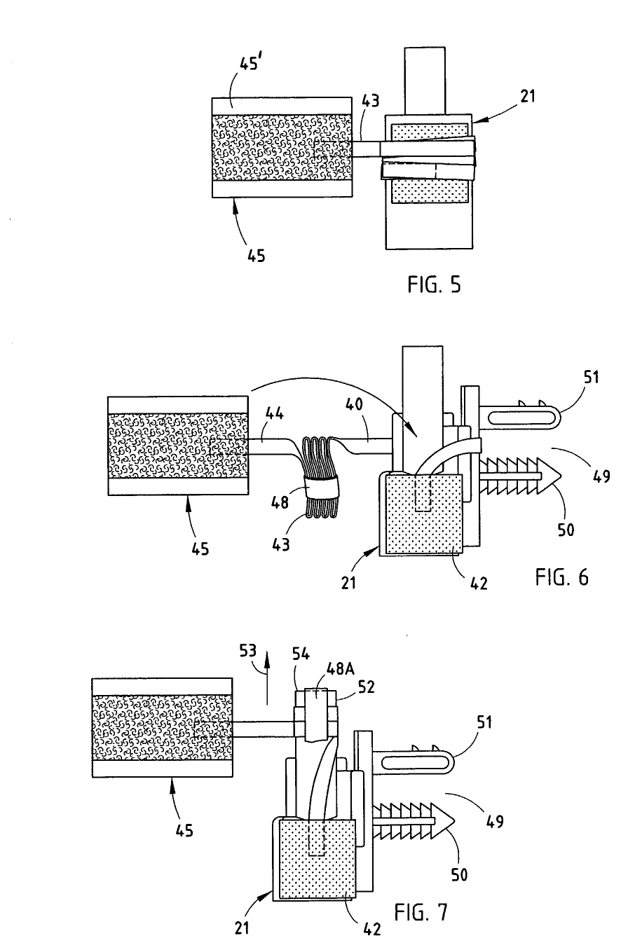

The component 21A (FIG. 5) does not include a recess 49 (nor protrusions 50 and 51), but the tether member 43 is held by both edges of the patches 42 and 45 engaging to contain the tether member 43. When patch 45 is released, the tether member 43 can be pulled off an end of the component 21A to provide a “section-by-section” stepped release, as each loop is pulled off an end of the component 21A.

In another form, the ribbon 43 (FIG. 6) is folded back and forth (separately from the component 21A) where it is releasably held by a sleeve-like holder 48. The holder 48 permits sections of the tether member 43 to be pulled loose one at a time. For example, the holder 48 can be a piece of tape doubled over to form a sleeve around the back-and-forth-folded tether ribbon 43. Other holders are also possible, such as clips, staples, wraps, rivet-like pins, tacky-adhesive, and the like. Advantageously, when the end 44 is pulled away from the end 40, the sections of ribbon 43 tend to pull out one at a time, causing only the necessary amount of the ribbon 43 to be extended. One advantage of ribbon 43 is that it is strong in tension and very flexible, but it is low in weight and very thin, such that it is easily positioned in small areas and it will not tend to vibrate, rattle, and make noise even if shaken. However, it is contemplated that a number of different shapes and materials can be used in place of the ribbon 43, including such things as strips, bands, strings, wires, cords, belts, and the like. These can be made out of basically any flexible material, such as cloth, fabric, plastic, leather, metal, composite, paper, and weavings.

FIG. 7 shows a holder 48A in the form of a ½″×⅞″ piece of tape (e.g. masking tape) that is applied perpendicularly across the winding of tether member 43, with the tether member 43 being wound onto a small end 52 of the housing to the component 21. By this arrangement, the tether member 43 can be pulled off in direction 53 one section at a time. The tape holder 48A can be further elongated and extended onto an end 54 of the small end 52 of the housing. Alternatively, it could be extended to wrap around the end 52 parallel the direction of the wound tether member 43. It is noted that the tape holder 48A can be on the same side or opposite side from the hook material 46.

The present invention is also contemplated to include patches made of various materials and configurations. All that is required is that the patch be securable to the connector, and to the end(s) of the tether. For example, patches could be used that attach to each other and/or to the tethered component by use of magnetic properties, by adhesive properties, or by mechanical properties (such as hook and holes, snap-attach arrangements, buttons, and the like).

It is to be understood that variations and modifications can be made on the aforementioned structure without departing from the concepts of the present invention, and further it is to be understood that such concepts are intended to be covered by the following claims unless these claims by their language expressly state otherwise.

I claim:

1. In an apparatus having an electrical component adapted for operative interconnection to a vehicle electrical system, an improvement comprising:
a tether having a first end attached to the electrical component and having a length wound around the electrical component and further having a second end releasably coupled to one of the first end and the electrical component to hold the length in a wound condition on the electrical component.

2. The apparatus defined in claim 1, wherein the electrical component includes an electrical conductor and at least one terminal adapted for connection to a control circuit.

3. The apparatus defined in claim 2, wherein the electrical component comprises an electrical circuit adapted for connection to an electrical control circuit in an automobile.

4. The apparatus defined in claim 1, wherein the tether includes a flexible but relatively non-stretchable tether member.

5. The apparatus defined in claim 4, wherein the tether member is a ribbon.

6. The apparatus defined in claim 1, wherein the first end includes a first patch and the second end includes a second patch adapted for releasable connection to the first patch.

7. The apparatus defined in claim 6, wherein the first and second patches include mating hook and loop material.

8. The apparatus defined in claim 7, wherein the first patch is adhered to a side of the electrical component.

9. The apparatus defined in claim 8, wherein the second patch has an adhesive side covered with a non-stick paper cover, the second patch being adapted for sticky attachment to a vehicle component.

10. The apparatus defined in claim 1, wherein the electrical component has a recess defined between two surfaces, and wherein the tether has a length wound around the component and through the recess between the two surfaces.

11. The apparatus defined in claim 1, wherein the tether includes a thin strip of material that includes the first and second ends, the first end being adhered to an inner end of the strip and the second end being adhered to the electrical component.

12. An apparatus for use in vehicles comprising:
an electrical component adapted for operative interconnection to a vehicle electrical system; and
a tether having a first end attached to the electrical component and having an elongated tethering member and further having a second end adapted for repeated releasable attachment to the first end, the elongated tethering member having a length defining a maximum distance but being arranged in a storage position to shorten an effective total distance between the first and second ends until the tethering member is extended to an extended position permitting the electrical component to be manipulated and used.

13. The apparatus defined in claim 12, wherein the second end includes a patch adapted for multiple releasable attachment to a mating surface at least three or more times.

14. The apparatus defined in claim 12, wherein the tethering member is made of a non-stretchable long member having sections, with some sections overlapping other sections.

15. The apparatus defined in claim 14, wherein the overlapping other sections include overlapping sections that are folded back and forth.

16. The apparatus defined in claim 14, wherein the overlapping other sections include overlapping sections that are wrapped around the electrical component.

17. The apparatus defined in claim 14, including a holder that releasably holds the sections in the storage position, but permits sections to be pulled loose one at a time when the second end is pulled away from the first end.

18. The apparatus defined in claim 14, wherein the holder includes a tape with adhesive for temporarily adheringly retaining the sections together.

19. The apparatus defined in claim 14, wherein the holder includes a mechanical device for clampingly retaining the sections together.

20. The apparatus defined in claim 14, wherein the tethering member is a ribbon.

21. A method comprising steps of:
providing an electrical component and a tether attached to the electrical component, the tether having an elongated tethering member positioned in a shortened storage position and having hook and loop material releasably holding the tethering member in the storage position; and
releasing and extending the tethering member to allow manipulation and use of the electrical component.

22. The method defined in claim 21, including winding the tethering member around the electrical component.

23. The method defined in claim 21, including releasably holding the tethering member in the storage position with a retention force that permits sections of the tethering member to be pulled free one at a time
